(19) United States
(12) Patent Application Publication
(10) Pub. No.: US 2004/0059658 A1
(43) Pub. Date: Mar. 25, 2004

(54) Method for providing protection to providers of seller financing

(76) Inventor: Gregory J. Sosville, Conifer, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/657,549

(22) Filed: Sep. 5, 2003

Related U.S. Application Data
(60) Provisional application No. 60/410,531, filed on Sep. 13, 2002.

(51) Int. Cl. G06F 17/60

(52) U.S. Cl. 705/35

(57) ABSTRACT

According to the invention, reducing risk to a seller when financing a sale to a buyer is disclosed. In one step, a business is transferred to a buyer. At least a portion of the sale is financed by the seller. Insurance is obtained from an entity that payments made from the buyer to the seller for that portion are made without default.

This application claims the benefit of and is a non-provisional of U.S. Provisional Application Serial No. 60/410,531 filed on Sep. 13, 2002, which is incorporated by reference in its entirety.

### BACKGROUND OF THE INVENTION

The present invention relates to a method for providing protection to providers of seller financing for buying and selling businesses.

Each year, over 250,000 small businesses transfer ownership. Approximately 70% of these sales involve seller financing, which is where the seller of a business will finance a buyer of that business to buy his business. This type of financing, like other types of financing, can be quite sophisticated. There are foreclosure laws to protect the financier, but those legal mechanisms are expensive and complex to apply. With over 250,000 small businesses transferring ownership each year and approximately 70% of these transactions involve seller financing, insurance or financial protection for seller financing would be well-received in the marketplace.

In seller financing of small businesses the collateral for the loan is typically an intangible asset, comprised primarily of future profits to be generated by the operation of the business. Intangible assets can loose all their value under certain circumstances while it is unlikely that tangible assets would loose all their value. For example, the brand for a cola bottler is an intangible asset while the bottling plants and other capital equipment are tangible assets. Poisoning of consumers, for example, could reduce the brand asset to near zero, but the tangible assets would still retain their value. An income stream to a seller financing a buyer that bought before the poisoning would be jeopardized by such a disaster.

### BRIEF DESCRIPTION OF THE DRAWINGS

The present invention is described in conjunction with the appended figures:

FIG. 1 is an overview of an embodiment of a seller financing transaction between two small businesses;

FIG. 2 is a listing of an embodiment of a method of providing protection to providers of seller financing for buying and selling businesses;

FIG. 3 is a listing of embodiments of credit scoring methodologies and embodiments of data used in performing the credit scoring function of the method;

FIG. 4 is a listing of embodiments of pricing and loss features in the method;

FIG. 5 is a graph of embodiments business lending loss rates for SBA business loans and a graph of business lending loss rates for the banking industry as a whole; and

FIG. 6 is a listing of information outlining what actions are taken in the event of a defaulted seller financing arrangement for an embodiment.

In the appended figures, similar components and/or features may have the same reference label.

### DETAILED DESCRIPTION OF THE PREFERRED EMBODIMENT

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

The present invention provides an overall method of providing financial protection to providers of seller financing for buying and selling businesses. In one embodiment, the method steps include utilizing existing credit scoring methodologies to evaluate the seller financing, charging a fee for providing the seller financing protection coverage, executing legal and financial transactions pertaining to providing the seller financing, and managing the risk of the seller financing. Risk sharing entities such as insurance companies, reinsurance companies and finance companies could also be used to help manage the risk of the seller financing portfolio notes.

Various embodiments have various features. For example, one embodiment facilitates small business sellers in providing financing for a portion of the sale price of their business to a purchaser. Insurance protection could be offered to the providers of seller financed business notes in some embodiments. A method and mechanism for transferring the risk from the current financing provider to a third party could be provided in some embodiments. A guarantee that the installment payments performed from the payor of a seller financing business transaction will continue regardless of that payor's performance could be provided in some embodiments.

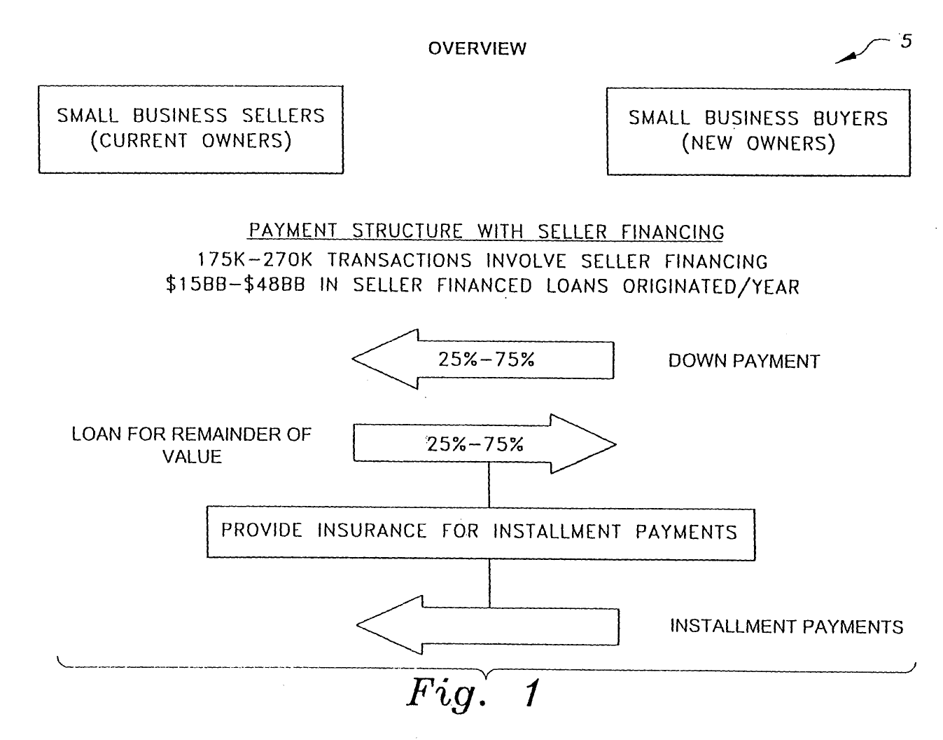

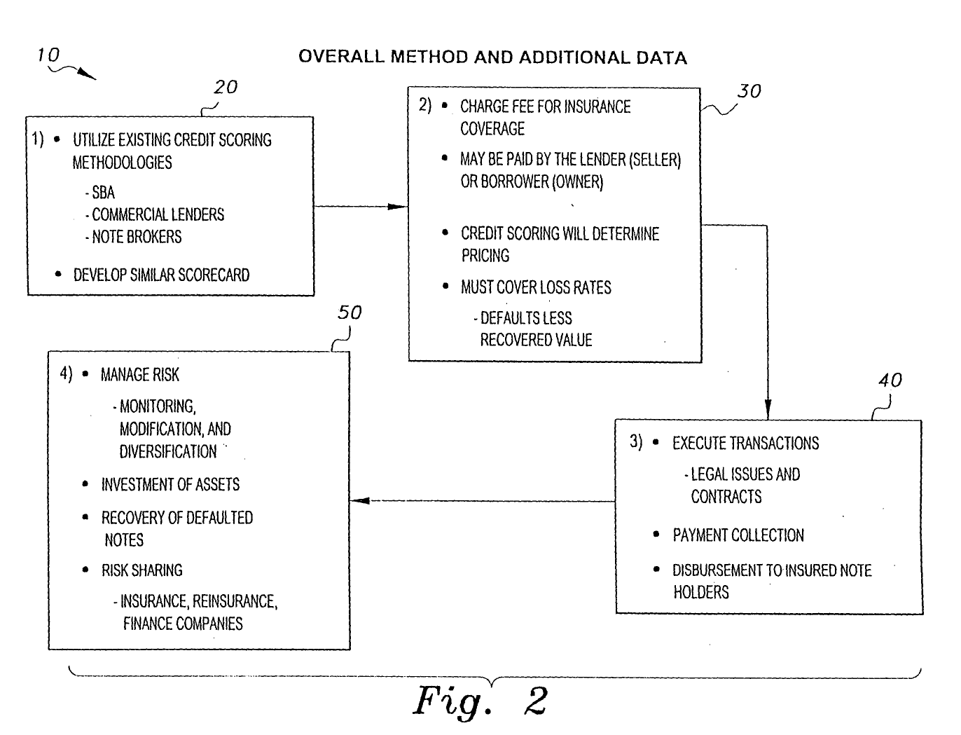

In one embodiment, the present invention includes a method for providing financial protection to providers of seller financing for buying and selling businesses. This type of financial protection is provided for buyers and sellers of small businesses (e.g., businesses with 1-500 employees or sole proprietors) in a typical small business buying and selling transaction 5, as is depicted in FIG. 1. Specifically, users of an overall method 10 shown in FIG. 2 guarantee payment of seller financed business notes for a fee. In other words, users of the overall method 10 will provide insurance to sellers of small businesses who are providing credit to purchasers as a part of the sale of the business. These seller-financed loans are typically a major portion of the seller's net worth.

Once a small business seller has found a small business buyer, the purchase transaction is often financed through seller financing. As shown in FIG. 1, some studys say 175,000-270,000 small business transactions done each year will require seller financing, which will account for $15-48 billion in seller financed loans each year. Usually, a down payment is provided on the cost of the acquired business with the remainder of the business being seller financed. The overall method 10 is designed to provide insurance for the installment payments of the seller financing.

With reference to FIG. 2, depicted are the steps of the overall method 10, which are comprised of utilizing existing credit scoring methodologies to evaluate the seller financing in step 20, charging a fee for providing the seller financing protection coverage in step 30, executing legal and financial transactions pertaining to providing the seller financing protection coverage in step 40 and managing risk of the seller financing cumulative portfolio in step 50.

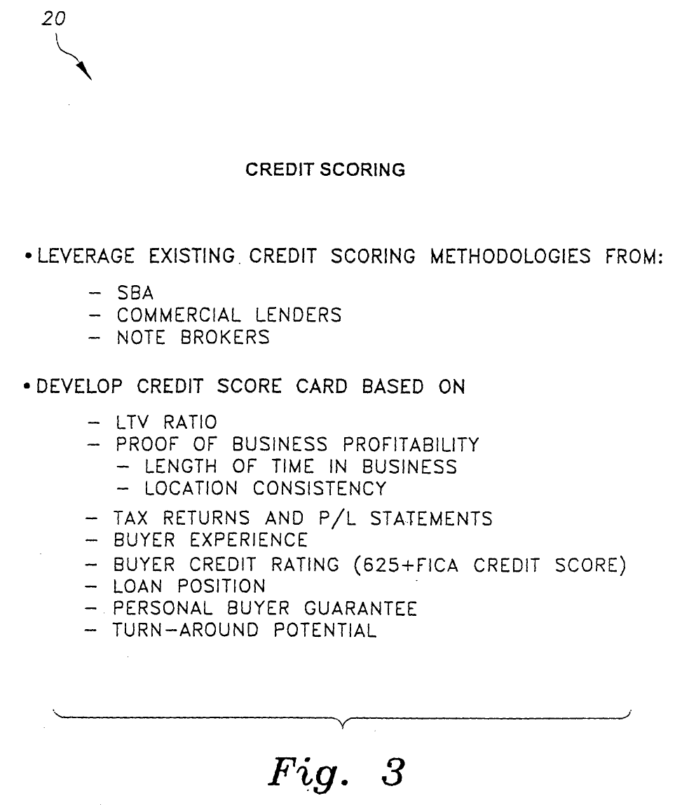

The first step 20 of the overall method 10 involves utilizing existing credit scoring methodologies to develop a similar scorecard credit scoring methodology to evaluate the seller financing. Methodologies include the credit scoring used by the small business administration (SBA), commercial lenders and discounted note brokers, with specific details being outlined in FIG. 3. Aspects of these different methodologies are combined into a similar credit scoring methodology used in the overall method 10.

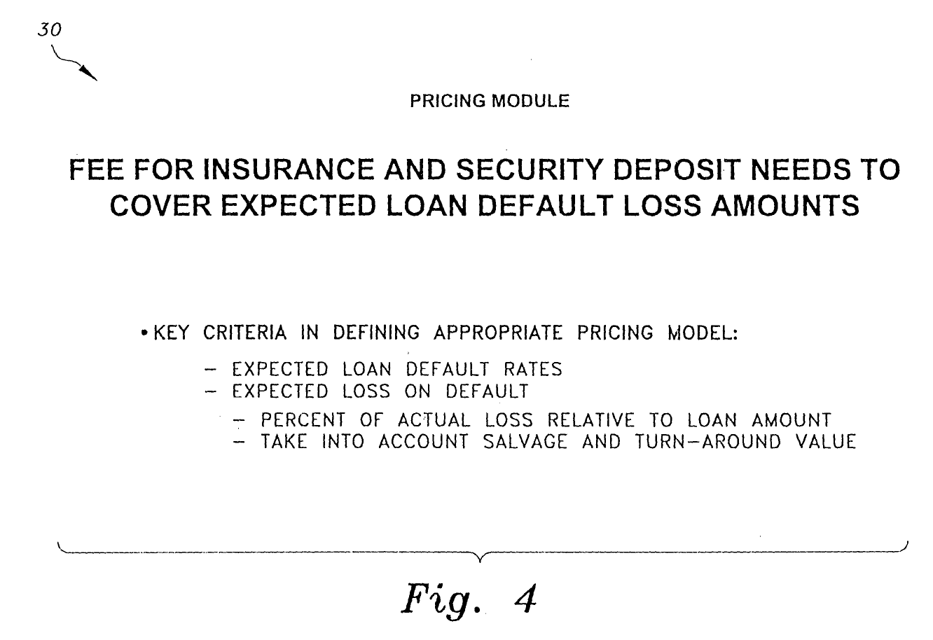

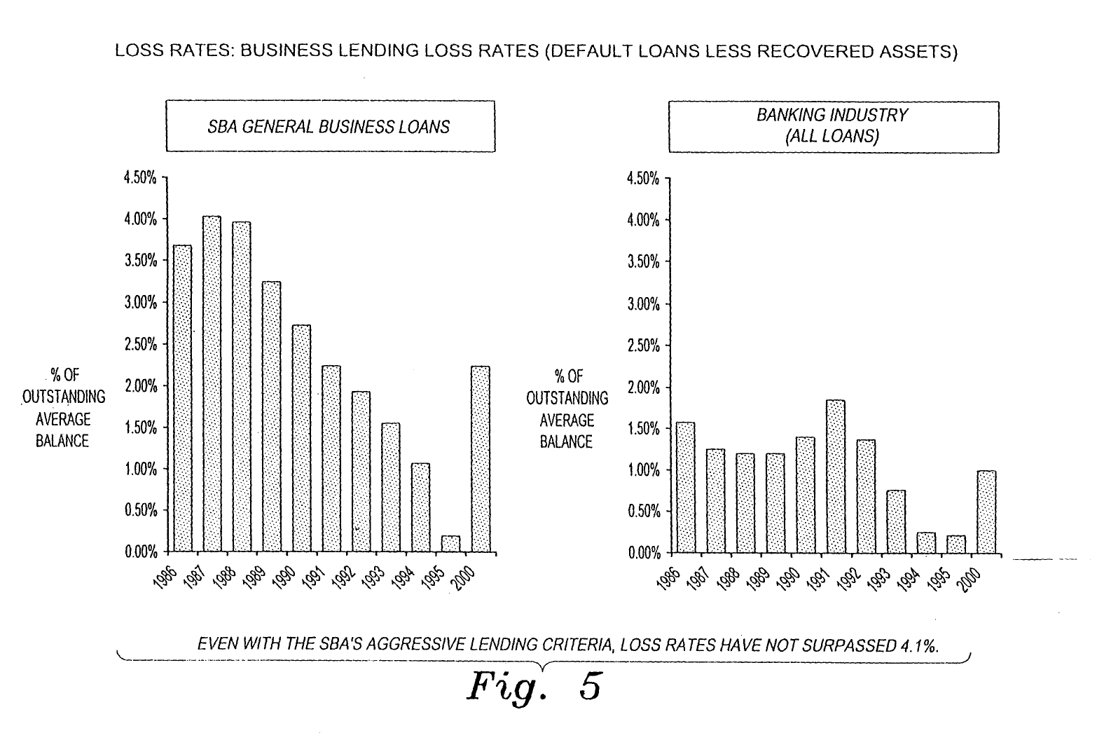

The second step 30 of the overall method 10 involves charging a fee for providing financial protection insurance coverage for a seller financing agreement. The fee can be paid by the seller or the owner of the business. Alternatively, the buyer could pay this fee. The credit scoring methodology step 20 is used to determine the pricing of the fee, which also covers the loss rates and any defaulted seller financing notes less their recovered value. More details on determining fees and loss rates are provided on FIG. 4 and FIG. 5.

The third step 40 of the overall method 10 involves executing the legal and financial transactions that are associated with providing the financial protection for the seller financing. In a typical transaction, the business seller receives a promissory note (not shown) from the business purchaser. A security instrument is filed with the Secretary of State detailing the terms of the financing provided, called a UCC-1 financing statement (not shown), is assigned in this embodiment. These two documents demonstrate that the business purchaser has agreed to execute the terms described in these two documents. The insuring entity providing the financial protection for the seller financing will become the note holder in this embodiment. This insuring entity is assigned the security instrument (UCC-1 financing statement) and the promissory note from the business seller. The business seller and the insuring entity providing the financial protection enter into a contract that guarantees monthly payments less the fee for insurance, regardless of the business purchaser's behavior. The business purchaser pays the insuring entity providing the financial protection rather than the business seller, otherwise there is no change for the business purchaser. The payments could be made with any periodicity such as yearly, bi-monthly, weekly, quarterly, etc. In other embodiments, the business seller could pay a lump insurance fee instead of periodic payments.

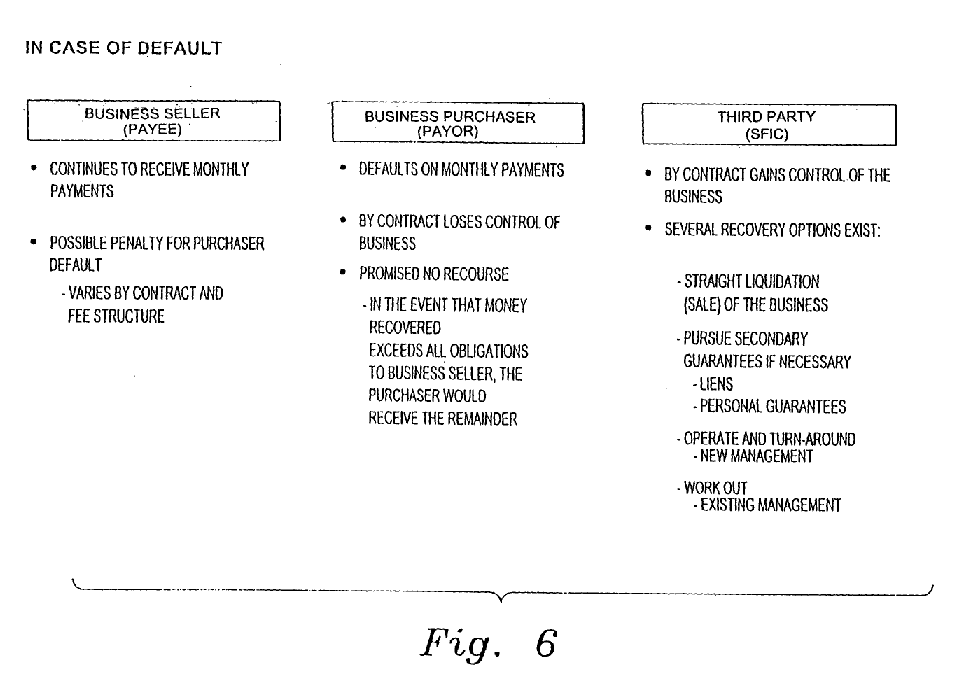

In a situation where the business purchaser defaults on the note, the following will occur to the parties involved with this embodiment. The business seller will continue to receive monthly payments from the insuring entity providing the financial protection. There may be a penalty for the business purchaser defaulting, which varies by individual contract and fee structure. The business purchaser will by contract, lose any control of the business once default has occurred. The business purchaser is also not promised any recourse for this loss. In the event that money recovered by the entity providing the financial protection for a seller financing exceeds all obligations to the business seller and the insuring entity's providing the financial protection costs, the business purchaser would receive the remainder. The insuring entity providing the financial protection of seller financing by contract, gains control of the business after a business purchaser defaults. Default options to the insuring entity providing the financial protection of seller financing are depicted in greater detail in FIG. 6.

The fourth and final step 50 of the overall method 10 involves the entity providing the financial protection of seller financing managing the risk of a seller financing cumulative portfolio. The portfolio of the insuring entity providing the financial protection of seller financing is monitored closely to ensure an acceptable default rate for the insurance fees gathered. Portfolio performance will be monitored by geographic region, industry sector and credit scoring variables. This will enable an entity providing the financial protection of seller financing to easily make modifications to the criteria for insuring seller financing portfolio notes. The experience of discounted note brokers and traditional lenders of ordinary skill in the art can also be used to better assess and target reasonable risks. Diversification within the portfolio of notes is a factor in mitigating risk.

As with any insurance related business, an important component of an entity providing the financial protection for seller financing will be appropriately managing and investing collected premiums. These investments offer an important revenue stream and is managed carefully to avoid capital shortfalls necessary for covering losses from defaulted seller financing notes. Risk sharing entities such as insurance companies, reinsurance companies and finance companies could also be used to manage the risk of the seller financing portfolio notes.

FIG. 3 outlines the use of some existing credit scoring methodologies. These credit scoring methodologies used by the small business administration (SBA), commercial lenders and discounted note brokers include utilizing loan to value ratio analysis, proof of profitability, length of time in business as well as buyer experience, financial analysis of tax returns and profit and loss statements, evaluation of credit rating (FICA score of 625+), loan position, personal buyer guarantees and turnaround potential. Different aspects of these credit scoring methodologies are brought together to form one improved overall credit scoring methodology used in the overall method 10.

FIG. 4 outlines a pricing module which can be used by an entity providing financial protection for seller financing agreements to charge an appropriate fee for providing selling finance financial protection. The demand for seller financing for buying and selling businesses often comes from business brokerage firms, closing agents and small business attorneys. The pricing and fees for insurance and security deposits cover expected loan default loss amounts. One criteria in defining appropriate and profitable pricing is based on expected loan default rates and precisely determining the expected losses from loan defaults. The percentage of actual loss relative to the loan amount could take into account both salvage and turnaround value. The expected loss on default in this embodiment is the percentage of actual loss relative to the loan amount, where the combination of default rates and expected losses on defaults is known as the loss rate.

FIG. 5 depicts two graphs that illustrate one estimate of the loss rates for SBA general business loans and banking industry loans across the board. The SBA and commercial lending experience with loss rates indicate likely loss rates for an entity providing financial protection for seller financing agreements. The SBA is not a for profit enterprise and that their loss rates will be expected to be higher than the banking industry loss rates and the loss rates expected for an entity providing financial protection for any seller financing agreements. This is because the SBA guarantees loans that could not be secured anywhere else. The SBA loss rates, however, do give a conservative indication of what expected loss rates will be for an entity providing financial protection for any seller financing agreements. Taking a negative view, one worse case scenario for an entity providing financial protection for any seller financing agreements appear to be a loss rate between 5% and 7%.

The overall size of the market and lack of alternatives, other than 20% to 30% discounting note brokers, indicate that an entity providing financial protection for any seller agreements should be successful, even under worse case scenarios for loss rates. The market will bear pricing that will allow for profitability in this sector. In the long term, as more historical data on loss rates for entities providing financial protection for seller agreements is accumulated, pricing will likely decrease. This decrease in pricing over time should be similar to what happened during the maturation process of the private mortgage insurance industry. Initially PMI (Private Mortgage Insurance) was initially fairly high priced because of the lack of certainty about previous loss rates. As the industry matured over time, the PMI risk became more predictable and their costs decreased over time.

As notes default for an entity for providing financial protection for seller financing agreements, there will also be an opportunity to recover as much value as possible from the underlying businesses. This capability helps maintain a profitable business. As shown in FIG. 6, there are several default options available which include straight liquidation or sale of the business, pursuing secondary buyer guarantees, operating and turning around the business with new management and executing a work-out agreement with the existing management. In these default agreements, an entity for providing financial protection for seller financing agreements would then assume control and will continue to provide monthly payments to a business seller. There is also a possible penalty for business purchaser default, which typically varies by individual contract and fee structure. When a business purchaser defaults on monthly payments, by contract they lose control of the business and control is passed onto the entity for providing financial protection for the seller financing agreement. The business purchaser may have no recourse where the money recovered in selling the business with a buyer in default exceeds the obligations to the business seller. Once business seller obligations, transaction costs and penalties are met by the proceeds of the business sale, the business purchaser would then receive any remaining money from the business in this embodiment.

In some business sales, the sale may be divided between tangible assets and intangible assets. The intangible assets may include such things as goodwill, intellectual property, intellectual capital, brands, future products, business opportunities, employees, business contacts, etc. These intangible assets are often difficult to finance through third parties who are often happy to finance the tangible assets. In some transactions, the tangible assets are mortgaged, but the intangible assets are seller-financed. A lump sum could be paid to the seller by the lender and an income stream would be promised to the seller from the buyer. Insurance could be provided by the entity for this income stream.

Many variations on the seller-financing of a business sale are possible. The business could be broken into tangible and intangible assets. A traditional loan from a third party could be obtained for the tangible portion of the business in a transaction separate from the sale of the intangible assets. The buyer may have to pay a down payment to the third party to obtain this loan. Alternatively, the seller could lease the tangible assets to the buyer, for example, lease the plant and equipment. The intangible assets are typically seller-financed in whole or in part as a transaction largely separated from the tangible asset transfer. The buyer may pay a down payment of 30% or less to the seller and promise a stream of payments for the remainder of the loan. In some cases, there is no down payment to the seller for these intangible assets and only a promise for periodic payments.

In some embodiments, the amount of the sale price for the business that is insured can vary. This fraction could be guided by the ratio of tangible to intangible assets, but the invention should not be so limited. In some cases, the insurance could be for 25%, 30%, 35%, 40%, 45%, 50%, 55%, 60%, 65%, 70%, 75%, 80%, 85%, 90%, 95%, or 100% of the sale price. The seller could have the option of how much of the price to insure and the insuring entity could adjust the insurance cost accordingly.

Some of the above embodiments contemplate that the seller would pay for the insurance. Other embodiments could have the buyer paying the insurance. The buyer could pay into an escrow account that is used to pay the insurance in some embodiments. The seller would use the escrow funds to pay the insuring entity.

While the principles of the invention have been described above in connection with specific apparatuses and methods, it is to be clearly understood that this description is made only by way of example and not as limitation on the scope of the invention.

What is claimed is:

1. A method for providing financial protection to providers of seller financing for buying and selling businesses, comprising the steps of:
utilizing existing credit scoring methodologies to evaluate risk in seller financing;
charging a fee for providing the seller financing protection coverage;
executing legal and financial transactions pertaining to providing the seller financing; and
managing risk of the seller financing.

2. The method according to claim 1, wherein intangible assets comprise 25%, 30%, 35%, 40%, 45%, 50%, 55%, 60%, 65%, 70%, 75%, 80%, 85%, 90%, 95%, or 100% of a seller-financed loan.

3. The method according to claim 1, further comprising steps of:
determining the portion of a seller-financed loan that corresponds to intangible assets; and
insuring that portion.

4. The method according to claim 1, wherein the seller financing is for that portion of a business that is substantially comprised of intangible assets.

5. The method according to claim 1, wherein existing credit scoring methodologies used by the small business administration (SBA), commercial lenders and discounted note brokers are utilized to evaluate the seller financing.

6. The method according to claim 5, wherein said fee for seller financing is based on the existing credit scoring methodologies.

7. The method according to claim 5, wherein existing credit scoring methodologies utilize loan to value ratio analysis, proof of profitability, buyer experience, financial analysis of tax returns and profit and loss statements, evaluation of credit rating (FICA score of 625+), loan position, personal buyer guarantee and turnaround potential.

8. The method according to claim 1, wherein said legal and financial transactions involve a UCC-1 financing statement and a promissory note.

9. The method according to claim 8, wherein said UCC-1 financing statement and said promissory note are assigned from a business seller in a seller financing transaction to an entity providing financial protection of seller financing.

10. The method according to claim 1, wherein additional steps include monitoring, modifying and diversifying a cumulative portfolio of the seller financing transactions.

11. The method according to claim 1, wherein risk sharing entities such as insurance companies, reinsurance companies and finance companies are used to manage the risk of the seller financing portfolio notes.

12. The method according to claim 1, wherein managing the risk of the seller financing includes recovering defaulted seller financing notes.

13. The method according to claim 1, wherein demand for seller financing for buying and selling businesses comes from business brokerages, closing agents and small business attorneys.

14. The method according to claim 1, wherein default options include straight liquidation or sale of a business, pursuing secondary buyer guarantees, operating and turning around a business with new management and executing a work-out agreement with the existing management.

15. A method for reducing risk to a seller when financing a sale to a buyer, the method comprising steps of:
determining factors relating to a risk of default by the buyer; and
insuring the risk of default.

16. The method for reducing risk to the seller when financing the sale to the buyer as recited in claim 15, wherein an insurer pays the seller when the buyer defaults.

17. The method for reducing risk to the seller when financing the sale to the buyer as recited in claim 15, further comprising a step of determining if the buyer has defaulted on payments for the sale.

18. The method for reducing risk to the seller when financing the sale to the buyer as recited in claim 15, wherein the determining step comprises a step of determining how much of the sale corresponds to intangible assets.

19. A method for reducing risk to a seller when financing a sale to a buyer, the method comprising steps of:
transferring a business to a buyer;
financing at least a portion of the transfer by the seller; and
obtaining insurance from an entity, other than the buyer or seller, that payments made from the buyer to the seller for the portion are made.

20. The method for reducing risk to the seller when financing the sale to the buyer as recited in claim 19, wherein the entity determines the risk of default by the buyer.

21. The method for reducing risk to the seller when financing the sale to the buyer as recited in claim 19, wherein the entity determines which portion of the business corresponds to tangible assets.
